(19) United States
(12) Patent Application Publication
(10) Pub. No.: US 2008/0028205 A1
(43) Pub. Date: Jan. 31, 2008

(54) Method and apparatus for authenticating a user

(76) Inventor: Cui Qing Yang, San Diego, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/497,210

(22) Filed: Jul. 31, 2006

(51) Int. Cl. H04L 9/00

(52) U.S. Cl. 713/156

(57) ABSTRACT

A system that authenticates a user on a computer system. During operation, the system receives an authentication request from the user. Next, the system receives a first multimedia data item from the user. The system then performs a transformation on the first multimedia data item. Next, the system determines if the transformation of the first multimedia data item matches authentication data for the user, wherein the authentication data for the user is a transformation of a second multimedia data item. If so, the system authenticates the user.

### BACKGROUND

### Related Art

The most common way to prevent unauthorized access to a computer system is to use password-based authentication techniques. Password-based authentication techniques provide a simple and inexpensive authentication mechanism that is relatively easy to use. A password is typically a word or a phrase that is used as a shared secret between a user and a target computer system.

The strength of a password depends on several factors, such as the length of the password, the sequence of characters in the password, and the type of characters in the password. Dictionary-based “password-cracking” applications operate by iterating through words that are contained in a password dictionary. These password dictionaries can contain: words from various languages; proper names of people and places; and commonly-used passwords. A typical password dictionary includes thousands or millions of entries. Hence, with high-speed computers a dictionary-based password attack can be completed in a fairly short amount of time.

One technique to make dictionary-based attacks less effective is to choose a longer password, which is more difficult to crack than a shorter password. However, even if the password contains multiple words, the list of possible combinations of words is still relatively small. Another technique is to vary the capitalization of the letters in the password. For example, a user can choose to use “ChEesE” instead of “cheese” as a password. However, changing the capitalization does not increase the password-search space substantially.

Another more robust technique that reduces the effectiveness of dictionary-based attacks is to use a password that contains a random or semi-random sequence of characters that includes non-alphabet characters (e.g., punctuation marks and numbers). Dictionary-based password attacks cannot be used to break such passwords with random or semi-random sequences of characters. However, brute-force password-cracking techniques can be used. Brute-force techniques iterate through all possible combination of characters until the password is found. The size of the password-search space for a random sequence of characters is proportional to an exponential function that depends on the number of characters that can be used for the password and the length of the password. For example, a password that contains 8 characters, where 50 possible characters can be used, results in a password-search space that contains approximately 3.9E13 combinations of characters. Hence, users who are concerned with security should choose a password that is a long set of random characters, which includes non-alphabet characters. Unfortunately, a long set of random characters is difficult to remember.

However, even if a user chooses a password with a long string of random characters, as computing power continues to increases, brute-force techniques for defeating password-based authentication techniques are becoming faster. Furthermore, parallel-processing environments and distributed-processing environments can be used to iterate through all possible combinations of characters to crack a password in days or even in hours.

Other authentication techniques such as two-factor authentication, which uses two independent authentication techniques to authenticate a user, and biometrics authentication, which uses biometric information such as fingerprints, palm prints, retinal scans, and phonetic signatures. Unfortunately, these authentication techniques require special hardware, such as biometric scanners and secure-token readers on the client system, as well as corresponding hardware and software infrastructure at the server, and hence are too complex and too expensive for mass deployment.

### SUMMARY

One embodiment of the present invention provides a system that authenticates a user on a computer system. During operation, the system receives an authentication request from the user. Next, the system receives a first multimedia data item from the user. The system then performs a transformation on the first multimedia data item. Next, the system determines if the transformation of the first multimedia data item matches authentication data for the user, wherein the authentication data for the user is a transformation of a second multimedia data item. If so, the system authenticates the user.

In a variation on this embodiment, prior to receiving the authentication request from the user, the system generates the authentication data by the following process. The system first receives a request to create authentication data for the user. Next, the system receives the second multimedia data item from the user. The system then performs a transformation on the second multimedia data item and associates the transformation of the second multimedia data item with the user to serve as the authentication data for the user. Next, the system stores the authentication data for the user on the computer system.

In a variation on this embodiment, while performing the transformation on the first multimedia data item, the system uses a hashing function on the first multimedia data item and encodes a binary representation of the result of a hashing function.

In a variation on this embodiment, the first multimedia data item is a portion of a first multimedia file, and the first multimedia data item is generated by applying a pattern selected by the user to the first multimedia file.

In a further variation, the second multimedia data item is a portion of a second multimedia file, and the second multimedia data item is generated by applying a pattern selected by the user to the second multimedia file.

In a further variation, prior to receiving the first multimedia data item, the system produces the authentication data for the user by the following process. The system presents a list of multimedia files to the user, wherein the list of multimedia files includes the first multimedia file. Next, the system receives a selection of the first multimedia file from the user. In response to the selection of the first multimedia file, the system displays the first multimedia file to the user. Next, the system presents a list of patterns to the user. The system then receives a selection of the pattern from the user. In response to the selection of the pattern, the system superimposes the selected pattern onto the first multimedia file to produce the authentication data for the user, wherein the user can move the selected pattern to a new position within the first multimedia file.

In a further variation, if a new multimedia file, a new pattern, and a new position are received from the user, the system superimposes the new pattern over the new position in the new multimedia file.

In a further variation, a multimedia file can include: an image file, an audio file, a video file, a text file, a combination of multimedia files, and any other multimedia file.

In a further variation, if the multimedia file is an image file, the pattern can include: a circle, a square, a triangle, a checkerboard pattern, a specified shape, a specified pattern, a combination of shapes, and a combination of patterns.

In a further variation, if the multimedia file is a video file, the pattern can include: a circle, a square, a triangle, a checkerboard pattern, a frame in the video file, a set of frames in the video file, a time interval, a specified shape, a specified pattern, a combination of shapes, and a combination of patterns.

In a further variation, if the multimedia file is an audio file, the pattern can include: a time interval, a set of time intervals, a set of notes, a track within the audio file, and a combination of patterns.

In a further variation, if the multimedia file is a text file, the pattern can include: a page of text, a paragraph of text, a selection of text, a set of selected text, and a combination of patterns.

In a further variation, attributes for the pattern can be modified by the user. The attributes for the pattern can include: a length, a width, a size, a time, a color, and any other attribute for the pattern.

In a further variation, a location for a placement of a pattern in a multimedia file is associated with a feature of the first multimedia file, wherein the feature of the first multimedia file can include an object within the first multimedia file, a time index within the first multimedia file, a note within the first multimedia file, and a melody within the first multimedia file.

### BRIEF DESCRIPTION OF THE FIGURES

FIG. 1 presents a block diagram illustrating a computer system that authenticates a user in accordance with an embodiment of the present invention.

FIG. 2A illustrates an image file and a pattern used to produce authentication data for a user in accordance with an embodiment of the present invention.

FIG. 2B illustrates a video file and a pattern used to produce authentication data for a user in accordance with an embodiment of the present invention.

FIG. 2C illustrates an audio file and a pattern used to produce authentication data for a user in accordance with an embodiment of the present invention.

FIG. 2D illustrates a text file and a pattern used to produce authentication data for a user in accordance with an embodiment of the present invention.

FIG. 3 presents a flow chart illustrating the process of authenticating a user in accordance with an embodiment of the present invention.

FIG. 4 presents a flow chart illustrating the process of creating authentication data for a user in accordance with an embodiment of the present invention.

FIG. 5 presents a flow chart illustrating the process of generating a multimedia data item used to authenticate a user in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention uses a multimedia data item to authenticate a user on the computer system. In one embodiment of the present invention, the multimedia data item is created from a portion of a multimedia file. For example, the multimedia data item can be a portion of an image or a portion of an audio file.

In one embodiment of the present invention, the multimedia data item is generated by applying a pattern to a multimedia file. In one embodiment of the present invention, the pattern can include a sequence, a square, a circle, a starting point, a length, and a size. As the result, the search space of a chosen pattern is large, which makes a potential the brute-force attack unrealistic.

Although the number of multimedia files and patterns can be large, a user does not need to remember low-level details such as a passphrase or a sequence of characters, but instead can remember high-level features such as the name of a song or a picture, a pattern structure (e.g., square or circle), and the starting point (which can be identified with a special features in a multimedia file, e.g., an object such as a flower in a picture, a coordinate, a starting time of a certain melody or note in a song or a video). As the result, such a chosen pattern is easier to remember and more secure than a complex password. For example, if a user writes down a specific coordinate to aid in remembering where to place a pattern within a multimedia file, even if an unauthorized user obtains this coordinate information, the attacker does not know which multimedia file and which pattern the user selected to use as a basis for the authentication data.

Note that the authentication principle of the present invention remains the same as the traditional password-based-authentication techniques. Consequently, present invention can co-exist with traditional password-based authentication systems. Hence, an implementation of the present invention can share most of the components of the prior art authentication systems. This makes it much easier and cheaper to migrate from existing password-based authentication system to this new authentication scheme.

### Computer System

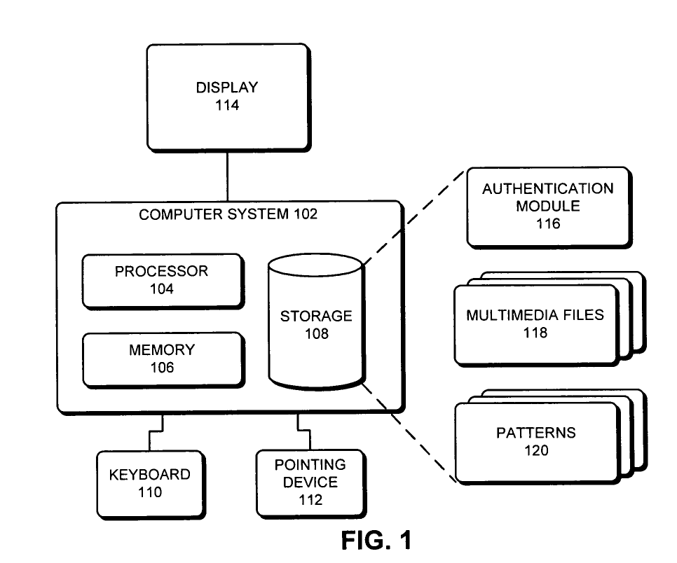

FIG. 1 presents a block diagram illustrating a computer system 102 that authenticates a user in accordance with an embodiment of the present invention. Computer system 102 can generally include any type of computer system, including, but not limited to, a computer system based on a microprocessor, a mainframe computer, a digital signal processor, a portable computing device, a personal organizer, a device controller, and a computational engine within an appliance.

Computer system 102 includes processor 104, memory 106, and storage device 108. Processor 104 can generally include any type of processor, including, but not limited to, a microprocessor, a mainframe computer, a digital signal processor, a personal organizer, a device controller and a computational engine within an appliance. Storage device 108 can include any type of non-volatile storage device that can be coupled to a computer system. This includes, but is not limited to, magnetic, optical, and magneto-optical storage devices, as well as storage devices based on flash memory and/or battery-backed up memory.

A user interacts with computer system 102 through keyboard 110 and pointing device 112. Pointing device 112 can include, but is not limited to, a mouse, a trackball, a pen, and a stylus. Computer system 102 is coupled to display 114, which displays the multimedia data to the user.

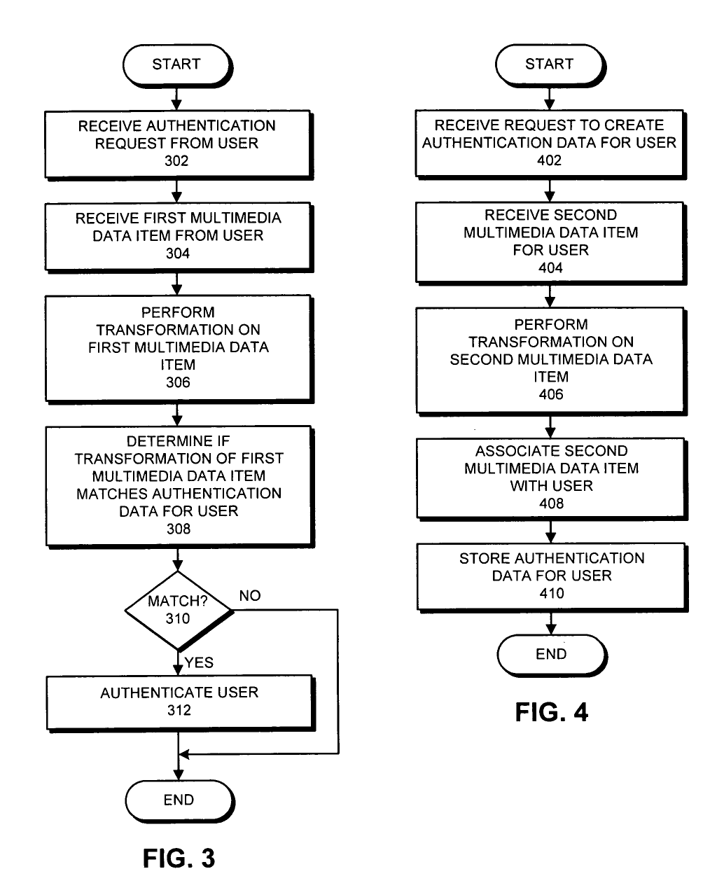

Storage device 108 includes authentication module 116, multimedia files 118, and patterns 120. Authentication module 116 can generally include any type of module that performs authorization, or authentication of a user or transaction. Note that authentication module 116 may or may not be contained within computer system 102. For example, authentication module 116 can be contained in a remote authentication server coupled to computer system 102 through a network. Authentication module 116 is described in more detail in reference to FIGS. 3 to 5 below.

In one embodiment of the present invention, multimedia files 118 are located on a client that is operated by the user. In another embodiment of the present invention, multimedia files 118 are located on a remote server. In another embodiment of the present invention, multimedia files 118 are stored in a removable-storage device, such as a universal serial bus (USB) memory device, that is coupled to computer system 102 during the authentication process.

In one embodiment of the present invention, patterns 120 are located on a client that is operated by the user. In another embodiment of the present invention, patterns 120 are located on a remote server. In another embodiment of the present invention, patterns 120 are stored in a removable-storage device, such as a universal serial bus (USB) memory device, that is coupled to computer system 102 during the authentication process.

In one embodiment of the present invention, a multimedia file can include, but is not limited to, an image file, an audio file, a video file, a text file, a combination of multimedia files, and any other multimedia file.

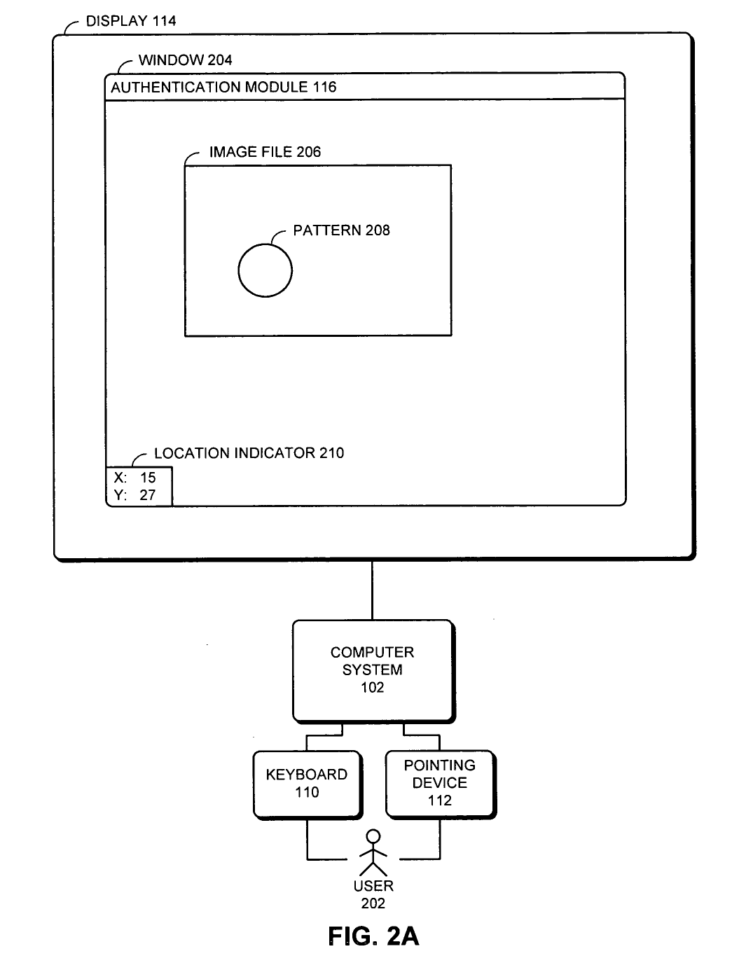

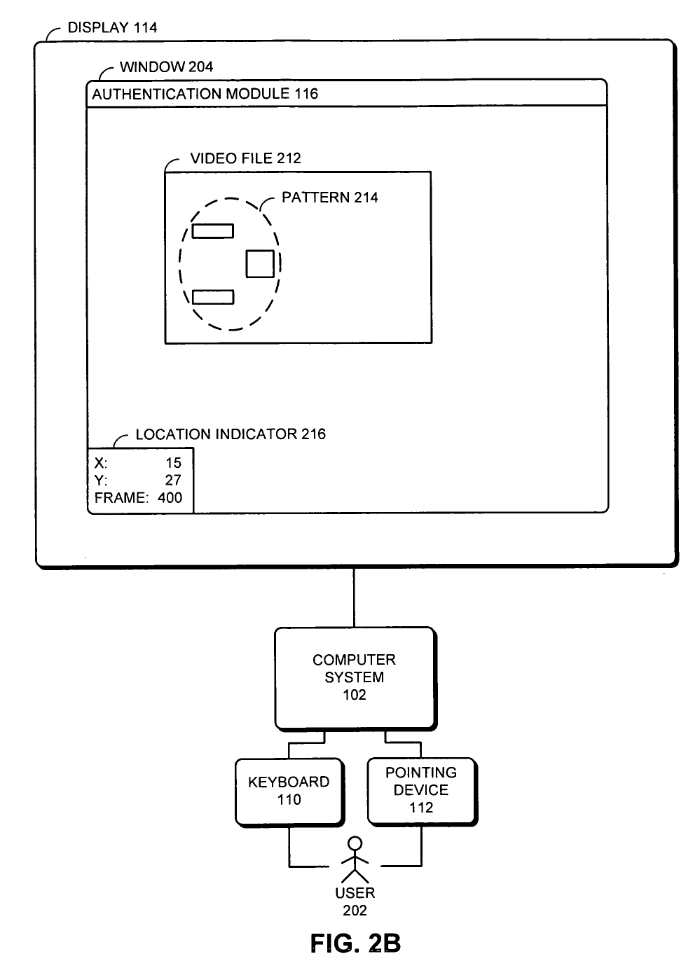

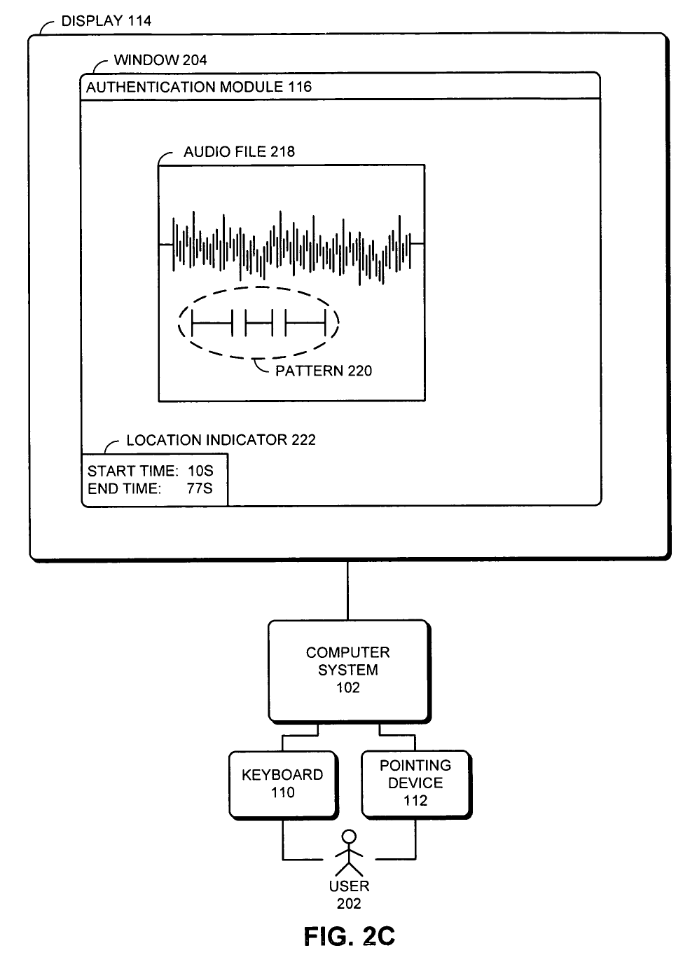

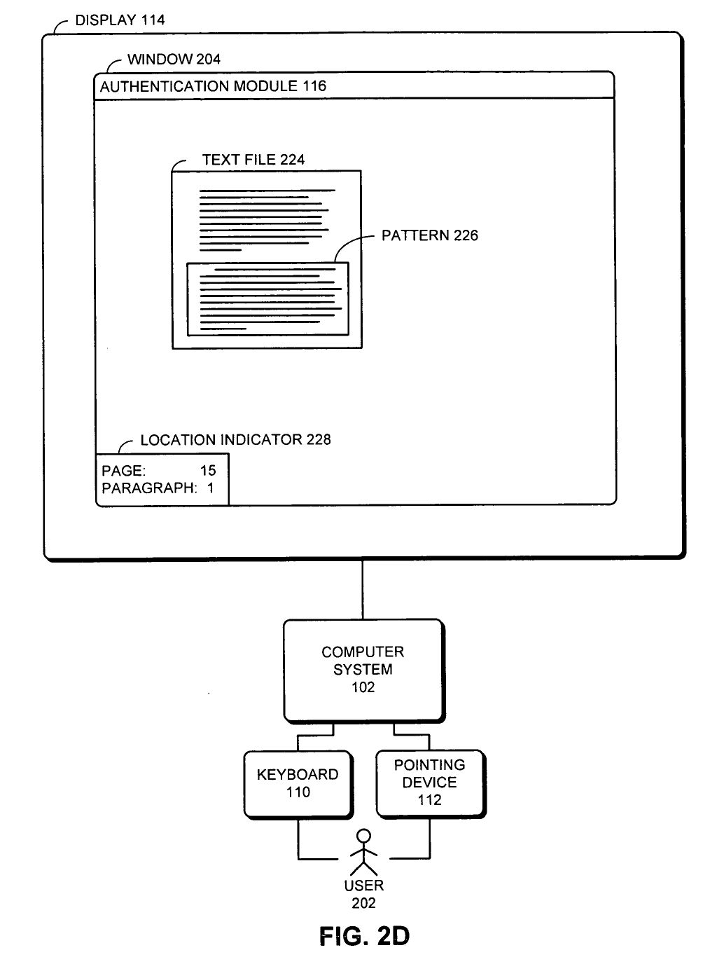

FIG. 2A illustrates image file 206 and pattern 208 used to produce authentication data for user 202 in accordance with an embodiment of the present invention. In one embodiment of the present invention, during the authentication process, computer system 102 presents user 202 with a list of multimedia files in window 204 within display 114, wherein window 204 contains the visual portions of authentication module 116.

In one embodiment of the present invention, user 202 can select a multimedia file not on the list by specifying the location of the multimedia file. In this embodiment, user 202 can enter the local path to the multimedia file if it is stored on a local computer system or can enter a network path, such as a universal resource locator (URL), for the multimedia file if the multimedia file is located on a remote computer system. In one embodiment of the present invention, user 202 uses pointing device 112 to select a multimedia file. In the example illustrated in FIG. 2A, user 202 selects image file 206.

In one embodiment of the present invention, computer system 102 presents a list of patterns to user 202. User 202 then selects a pattern that is used to generate authentication data for the user. In this example, user 202 selects pattern 208, which is a circle. In one embodiment of the present invention, user 202 can modify attributes for the patterns. For example, user 202 can specify a larger radius for pattern 208. In one embodiment of the present invention, the attributes for the pattern can include: a length, a width, a size, a time, a color, and any other attribute for the pattern.

In one embodiment of the present invention, the patterns for an image file can include, but are not limited to, a circle, a square, a triangle, a checkerboard pattern, a specified shape, a specified pattern, a combination of shapes, and a combination of patterns.

Note that the sequence in which computer system 102 displays the multimedia files and the patterns is not important. Hence, computer system 102 can display the list of multimedia files and the list of patterns simultaneously. Similarly, computer system 102 can display the list of patterns before displaying the list of multimedia files.

In one embodiment of the present invention, user 202 moves pattern 208 to a location associated with a certain feature (e.g., an object such as a flower) within image file 206 to select a portion of image file 206 to be used as the authentication data for user 202. In one embodiment of the present invention, location indicator 210 displays the current position of pattern 208 within image file 206. In one embodiment of the present invention, user 202 moves pattern 208 to the location within image file 206 which was used during an authentication-data-generation phase.

In one embodiment of the present invention, computer system 102 determines if the portion of image file 206 that is selected using pattern 208 matches authentication data for user 202. In one embodiment of the present invention, the authentication data for user 202 is a binary representation of a multimedia data item that was previously submitted by user 202 during an authentication-data-generation phase. In another embodiment of the present invention, the authentication data for user 202 is a hash of the binary representation of a multimedia data item that was previously submitted by user 202 during the authentication-data-generation phase.

FIG. 2B illustrates video file 212 and pattern 214 used to produce authentication data for a user in accordance with an embodiment of the present invention. FIG. 2B differs from FIG. 2A only in the contents of window 204, which contains authentication module 116. Hence, the discussion in FIG. 2A applies to FIG. 2B with a few differences. In the example illustrated in FIG. 2B, user 202 selects video file 212 to serve as a basis for generating authentication data for user 202. Pattern 214 is a set of rectangles, which defines the portions of video file 212 that are used as authentication data for user 202.

In one embodiment of the present invention, the patterns for a video file can include, but are not limited to, a circle, a square, a triangle, a checkerboard pattern, a frame in the video file, a set of frames in the video file, a time interval, a specified shape, a specified pattern, a combination of shapes, and a combination of patterns

In one embodiment of the present invention, user 202 selects a location within video file 212, wherein the location includes a horizontal coordinate, a vertical coordinate, and a frame number. In this example, location indicator 216 indicates that user 202 applied pattern 214 to the coordinate (15, 27) in frame 400. In another embodiment of the present invention, user 202 can select a combination of frames onto which pattern 214 is applied.

FIG. 2C illustrates audio file 218 and pattern 220 used to produce authentication data for a user in accordance with an embodiment of the present invention. FIG. 2C differs from FIG. 2A only in the contents of window 204, which contains authentication module 116. Hence, the discussion in FIG. 2A applies to FIG. 2C with a few differences. In the example illustrated in FIG. 2C, user 202 selects audio file 218 to serve as a basis for generating authentication data for user 202. Pattern 220 is a set of time intervals, which defines the portions of audio file 218 that are used as authentication data for user 202.

In one embodiment of the present invention, the patterns for an audio file can include, but are not limited to, a time interval, a set of time intervals, a set of notes, a track within the audio file, and a combination of patterns.

In one embodiment of the present invention, user 202 selects a location within audio file 218, wherein the location includes a start time and an end time. In this example, location indicator 222 indicates that user 202 applied pattern 220 to the time interval between 10 seconds and 77 seconds in audio file 218.

FIG. 2D illustrates text file 224 and pattern 226 used to produce authentication data for user 202 in accordance with an embodiment of the present invention. FIG. 2D differs from FIG. 2A only in the contents of window 204, which contains authentication module 116. Hence, the discussion in FIG. 2A applies to FIG. 2D with a few differences. In the example illustrated in FIG. 2D, user 202 selects text file 224 to serve as a basis for generating authentication data for user 202. Pattern 226 select text within text file 224, which defines the portions of text file 224 that are used as authentication data for user 202.

In one embodiment of the present invention, the patterns for a text file can include, but are not limited to, a page of text, a paragraph of text, a selection of text, a set of selected text, and a combination of patterns.

In one embodiment of the present invention, user 202 selects a location within text file 224, wherein the location includes a page number and a paragraph number. In one embodiment of the present invention, user 202 can select multiple pages to serve as a basis for generating the authentication data for the user. In this example, location indicator 228 indicates that user 202 applied pattern 226 to paragraph 1 on page 15 in text file 224.

### Authenticating a User

FIG. 3 presents a flow chart illustrating the process of authenticating a user in accordance with an embodiment of the present invention. The process begins when the system receives an authentication request from the user (step 302). Next, the system receives a first multimedia data item from the user (step 304). The system then performs a transformation on the first multimedia data item (step 306). In one embodiment of the present invention, while performing the transformation on the first multimedia data item, the system uses a hashing function on the first multimedia data item and encodes a binary representation of the result of a hashing function.

Next the system determines if the transformation of the first multimedia data item matches authentication data for the user, wherein the authentication data for the user is a transformation of a second multimedia data item (step 308). If so (step 310—yes), the system authenticates the user (step 312).

In one embodiment of the present invention, a binary representation of the first multimedia data item is transmitted from the user to the computer system.

In one embodiment of the present invention, a hash function is used to generate a hash of the first multimedia data item. This hash is then used to authenticate a user. The hash function generates a string of characters that represents the multimedia data item. This hash is then stored in a user-authentication database and later used to authenticate a user. Typically, the string of characters in a hash has a fixed length regardless of the size of the multimedia data item. Furthermore, the hash of a given multimedia data item is unique. Using a hash function is beneficial because the actual multimedia data item does not need to be stored in the user-authentication database.

In one embodiment of the present invention, the multimedia data item (or hash of the multimedia data item) is transmitted using a secure channel, such as a secure sockets layer (SSL) channel.

FIG. 4 presents a flow chart illustrating the process of creating authentication data for a user in accordance with an embodiment of the present invention. In one embodiment of the present invention, the authentication data is the second multimedia data item. The process begins when the system receives a request to create authentication data for the user (step 402). Next, the system receives the second multimedia data item (step 404). The system then performs a transformation on the second multimedia data item (step 406) and associates the transformation of the second multimedia data item with the user to serve as the authentication data for the user (step 408). Next, the system stores the authentication data for the user on the computer system (step 410).

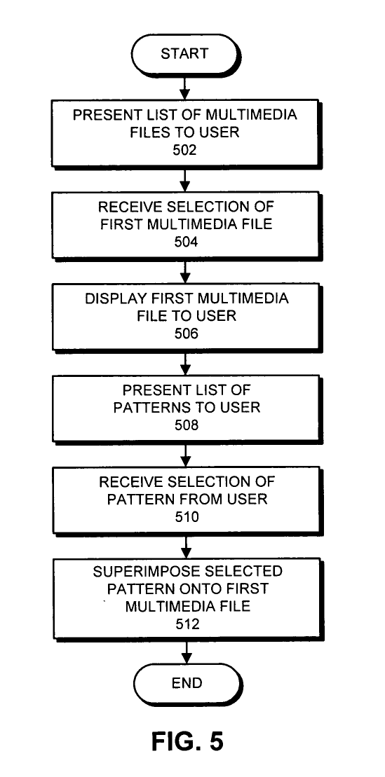

FIG. 5 presents a flow chart illustrating the process of generating a multimedia data item used to authenticate a user in accordance with an embodiment of the present invention. The process begins when the system presents a list of multimedia files to the user, wherein the list of multimedia files includes the first multimedia file (step 502). Next, the system receives a selection of the first multimedia file from the user (step 504). In response to the selection of the first multimedia file, the system displays the first multimedia file to the user (step 506). Next, the system presents a list of patterns to the user (step 508). The system then receives a selection of the pattern from the user (step 510). In response to the selection of the pattern, the system superimposes the selected pattern onto the first multimedia file to produce the authentication data for the user, wherein the user can move the selected pattern to a new position within the first multimedia file (step 512).

In one embodiment of the present invention, if a new multimedia file, a new pattern, and a new position are received from the user, the system superimposes the new pattern over the new position in the new multimedia file.

In one embodiment of the present invention, a user chooses the multimedia file, chooses the pattern, and chooses the placement of the pattern within the multimedia file using a pointing device instead of using a keyboard. This embodiment of the present invention protects against keystroke-snooping programs.

One embodiment of the present invention is implemented as a front-end application on a client computer system.

In one embodiment of the present invention, the application is a multimedia-file-handler application that can open different type of files, including, but not limited to, text files, image files, video files, and audio files.

In one embodiment of the present invention, the multimedia-file-handler application provides a list of patterns that can be applied to the multimedia file to generate a multimedia data item that is used to authenticate the user. In one embodiment of the present invention, the multimedia-file-handler application displays the multimedia file to the user and overlays a pattern over the multimedia file. In this embodiment, the multimedia-file-handler application transmits the multimedia data item to server to authenticate a user.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for authenticating a user on a computer system, comprising:
receiving an authentication request from the user;
receiving a first multimedia data item from the user;
performing a transformation on the first multimedia data item;
determining if the transformation of the first multimedia data item matches authentication data for the user, wherein the authentication data for the user is a transformation of a second multimedia data item; and
if so, authenticating the user.

2. The method of claim 1, wherein prior to receiving the authentication request from the user, the method further comprises generating the second multimedia data item by:
receiving a request to create authentication data for the user;
receiving the second multimedia data item from the user;
performing a transformation on the second multimedia data item;
associating the transformation of the second multimedia data item with the user to serve as the authentication data for the user; and
storing the authentication data for the user on the computer system.

3. The method of claim 1, wherein performing the transformation on the first multimedia data item involves:
using a hashing function on the first multimedia data item; and
encoding a binary representation of a result of a hashing function on the first multimedia data item.

4. The method of claim 1,
wherein the first multimedia data item is a portion of a first multimedia file; and
wherein the first multimedia data item is generated by applying a pattern selected by the user to the first multimedia file.

5. The method of claim 4,
wherein the second multimedia data item is a portion of a second multimedia file; and
wherein the second multimedia data item is generated by applying a pattern selected by the user to the second multimedia file.

6. The method of claim 5, wherein prior to receiving the first multimedia data item, the method further comprises producing the authentication data for the user by:
presenting a list of multimedia files to the user, wherein the list of multimedia files includes the first multimedia file;
receiving a selection of the first multimedia file from the user;
in response to the selection of the first multimedia file, displaying the first multimedia file to the user;
presenting a list of patterns to the user;
receiving a selection of the pattern from the user; and
in response to the selection of the pattern, superimposing the selected pattern onto the first multimedia file to produce the authentication data for the user, wherein the user can move the selected pattern to a new position within the first multimedia file.

7. The method of claim 6, wherein if a new multimedia file, a new pattern, and a new position are received from the user, the method further comprises superimposing the new pattern over the new position in the new multimedia file.

8. The method of claim 5, wherein a multimedia file can include:
an image file;
an audio file;
a video file;
a text file;
a combination of multimedia files; and
any other multimedia file.

9. The method of claim 8, wherein if the multimedia file is an image file, the pattern can include:
a circle;
a square;
a triangle;
a checkerboard pattern;
a specified shape;
a specified pattern;
a combination of shapes; and
a combination of patterns.

10. The method of claim 8, wherein if the multimedia file is a video file, the pattern can include:
a circle;
a square;
a triangle;
a checkerboard pattern;
a frame in the video file;
a set of frames in the video file;
a time interval;
a specified shape;
a specified pattern;
a combination of shapes; and
a combination of patterns.

11. The method of claim 8, wherein if the multimedia file is an audio file, the pattern can include:
a time interval;
a set of time intervals;
a set of notes;
a track within the audio file; and
a combination of patterns.

12. The method of claim 8, wherein if the multimedia file is a text file, the pattern can include:
a page of text;
a paragraph of text;
a selection of text;
a set of selected text; and
a combination of patterns.

13. The method of claim 4,
wherein attributes for the pattern can be modified by the user; and
wherein the attributes for the pattern can include:
a length;
a width;
a size;
a time;
a color; and
any other attribute for the pattern.

14. The method of claim 4, wherein a location for a placement of a pattern in a multimedia file is associated with a feature of the first multimedia file;
wherein the feature of the first multimedia file can include:
an object within the first multimedia file;
a time index within the first multimedia file;
a note within the first multimedia file; and
a melody within the first multimedia file.

15. A computer-readable storage medium storing instructions that when executed by a computer cause the computer to perform a method for authenticating a user on a computer system, wherein the method comprises:
receiving an authentication request from the user;
receiving a first multimedia data item from the user;
performing a transformation on the first multimedia data item;
determining if the transformation of the first multimedia data item matches authentication data for the user, wherein the authentication data for the user is a transformation of a second multimedia data item; and
if so, authenticating the user.

16. The computer-readable storage medium of claim 15, wherein prior to receiving the authentication request from the user, the method further comprises generating the second multimedia data item by:
receiving a request to create authentication data for the user;
receiving the second multimedia data item from the user;
performing a transformation on the second multimedia data item;
associating the transformation of the second multimedia data item with the user to serve as the authentication data for the user; and
storing the authentication data for the user on the computer system.

17. The computer-readable storage medium of claim 15, wherein performing the transformation on the first multimedia data item involves:
using a hashing function on the first multimedia data item; and
encoding a binary representation of a result of a hashing function on the first multimedia data item.

18. The computer-readable storage medium of claim 15,
wherein the first multimedia data item is a portion of a first multimedia file; and
wherein the first multimedia data item is generated by applying a pattern selected by the user to the first multimedia file.

19. The computer-readable storage medium of claim 18,
wherein the second multimedia data item is a portion of a second multimedia file; and
wherein the second multimedia data item is generated by applying a pattern selected by the user to the second multimedia file.

20. The computer-readable storage medium of claim 19, wherein prior to receiving the first multimedia data item, the method further comprises producing the authentication data for the user by:
presenting a list of multimedia files to the user, wherein the list of multimedia files includes the first multimedia file;
receiving a selection of the first multimedia file from the user;
in response to the selection of the first multimedia file, displaying the first multimedia file to the user;
presenting a list of patterns to the user;
receiving a selection of the pattern from the user; and
in response to the selection of the pattern, superimposing the selected pattern onto the first multimedia file to produce the authentication data for the user, wherein the user can move the selected pattern to a new position within the first multimedia file.

21. The computer-readable storage medium of claim 20, wherein if a new multimedia file, a new pattern, and a new position are received from the user, the method further comprises superimposing the new pattern over the new position in the new multimedia file.

22. The computer-readable storage medium of claim 19, wherein a multimedia file can include:
an image file;
an audio file;
a video file;
a text file;
a combination of multimedia files; and
any other multimedia file.

23. The computer-readable storage medium of claim 22, wherein if the multimedia file is an image file, the pattern can include:
a circle;
a square;
a triangle;
a checkerboard pattern;
a specified shape;
a specified pattern;
a combination of shapes; and
a combination of patterns.

24. The computer-readable storage medium of claim 22, wherein if the multimedia file is a video file, the pattern can include:
a circle;
a square;
a triangle;
a checkerboard pattern;
a frame in the video file;
a set of frames in the video file;
a time interval;
a specified shape;
a specified pattern;
a combination of shapes; and
a combination of patterns.

25. The computer-readable storage medium of claim 22, wherein if the multimedia file is an audio file, the pattern can include:
a time interval;
a set of time intervals;
a set of notes;
a track within the audio file; and
a combination of patterns.

26. The computer-readable storage medium of claim 22, wherein if the multimedia file is a text file, the pattern can include:
a page of text;
a paragraph of text;
a selection of text;
a set of selected text; and
a combination of patterns.

27. The computer-readable storage medium of claim 18,
wherein attributes for the pattern can be modified by the user; and
wherein the attributes for the pattern can include:
a length;
a width;
a size;
a time;
a color; and
any other attribute for the pattern.

28. An apparatus that authenticates a user on a computer system, comprising:
an authentication mechanism configured to:
receive an authentication request from the user;
receive a first multimedia data item from the user;
perform a transformation on the first multimedia data item;
determine if the transformation of the first multimedia data item matches authentication data for the user, wherein the authentication data for the user is a transformation of a second multimedia data item; and
if so, to authenticate the user.

29. The apparatus of claim 28, wherein prior to receiving the authentication request from the user, the authentication mechanism is configured to generate the second multimedia data item by:
receiving a request to create authentication data for the user;
receiving the second multimedia data item from the user;
perform a transformation on the second multimedia data item;
associating the transformation of the second multimedia data item with the user to serve as the authentication data for the user; and
storing the authentication data for the user on the computer system.

30. The apparatus of claim 28, wherein while performing the transformation on the first multimedia data item, the authentication mechanism is configured to:
use a hashing function on the first multimedia data item; and to
encode a binary representation of a result of a hashing function on the first multimedia data item.
